(19) United States
(12) Patent Application Publication
(10) Pub. No.: US 2002/0185013 A1
(43) Pub. Date: Dec. 12, 2002

(54) Cooking tray for fatty meats and other foods

(76) Inventor: Larry N. London, Fairfax Station, VA (US)

Correspondence Address: Richard C. Litman, LITMAN LAW OFFICES, LTD., P.O. Box 15035, Arlington, VA, 22215, US

(21) Appl. No.: 10/141,006

(22) Filed: May 9, 2002

Related U.S. Application Data
(60) Provisional application No. 60/289,522, filed on May 9, 2001.

(51) Int. Cl. A47J 9/00

(52) U.S. Cl. 99/450; 99/448

(57) ABSTRACT

A disposable, broiler cooking tray for meats, particularly bacon, or other foods, has a double-layered foil tray with a perforated surface, under which lies an absorbent material. The bottom layer can be heat-resistant plastic. No absorbent material is present in another embodiment. When cooking meat under the broiler the grease that is produced is drawn through the perforations by the absorbent material, or passes through under influence of gravity, and is trapped between the top and bottom layers. The disposable bacon cooking tray is designed to virtually eliminate the clean-up of cooking meat, and other food products, improve on the taste and reduce the calories by reducing the residual grease that remains after cooking is complete.

### CROSS-REFERENCE TO RELATED APPLICATION

This application claims the benefit of U.S. Provisional Patent Application Serial No. 60/289,522, filed May 9, 2001.

### BACKGROUND OF THE INVENTION

1. Field of the Invention

The present invention relates to a disposable tray for cooking fatty meat products, particularly a disposable tray for cooking meats (e.g., bacon, sausage, scrapple, etc.) under a broiler. The tray can be constructed as a point of purchase package with bacon or other meat products. The tray is then used for cooking the bacon or other meat thereon, and then discarded. The construction of the disposable cooking tray and method of using same are described and claimed herein.

In particular, the invention relates to grease-absorbent cooking tray which, in one embodiment, includes a multi-ply pad, adapted for absorbing the residual grease from the cooking of meat. The pad is sandwiched between a perforated upper foil and an impervious bottom foil. The grease drains through the perforated upper layer and is trapped in the absorbent material. Alternatively, the interior absorbent pad may not be present. Thus, a hollow chamber or void is defined between the upper and bottom foils. In this case, the foil upper and bottom layers are made sufficiently shape-retaining so as not to collapse during use. The invention allows the user to cook (broil) bacon, sausage, scrapple, etc. without a messy clean-up after the cooking, and significantly reduces smoke and odor. The result is greaseless, appetizing bacon strips, sausage patties or links, scrapple, etc..

2. Description of Related Art

There are essentially three ways to cook bacon, sausage, scrapple, etc., either in a frying pan, in a microwave oven, or under a broiler. All three methods produce some volume of grease that must be disposed of as well as a mess to clean up after cooking. Traditionally, bacon has been cooked in a frying pan, with the bacon allowed to sizzle in its own grease. Cooking pads adapted for absorbing bacon grease, particularly during the cooking of bacon in the microwave oven, have been the subject of earlier patents. Examples of previous cooking trays are found in the following United States patents.

| Patent No. | Inventor |
|---|---|
| Des. 284,543 | Huls |
| Des. 309,234 | Howell |
| 4,112,833 | Oda et al. |
| 4,873,101 | Larson et al. |
| 4,950,524 | Hacker |
| 4,954,356 | Kappes |
| 5,093,176 | Pribonic et al. |
| 5,094,869 | Brown, Jr. |
| 5,096,722 | Bair |
| 5,124,519 | Roy et al. |
| 5,814,396 | Weidner et al. |
| 5,935,478 | Parduhn |

Relevant foreign patent and publication disclosures include:

| Patent No. | Country & Date |
|---|---|
| 0 320 314 A2 | Europe, 06/1989 |
| 0 360 929 A1 | Europe, 04/1990 |
| GB 2 226 220 A | United Kingdom, 06/1990 |

Of particular interest is the patent to Hacker which discloses a three-ply laminate for absorbing fat produced during the cooking of bacon. The design patent to Howell appears to show a perforated cooking pad. The patent to Pribonic et al. shows a multi-ply, composite, bacon cooking device for absorbing the greasy by-product of cooking bacon and other fatty foods. The patent to Weidner describes a disposable, three-layered, grease absorbing pad for collecting cooking grease. The remainder of the above-listed patents were selected to further illustrate patents in the field of bacon grease absorbing pads.

The broiler has been used for cooking meats such as bacon to reduce the amount of grease surrounding the bacon during the cooking process. The grease, however, can accumulate in the broiler pan and still saturate the meat, or even catch on fire. Or, the bacon is cooked on aluminum foil placed on top of the broiler tray, and the meat (e.g., bacon) is cooked in its own grease similar to cooking in a frying pan.

The present invention provides for an easy way to cook various meats under the broiler. and none of the above related inventions and patents, taken either singly or in combination, is seen to describe the instant invention as claimed.

### SUMMARY OF THE INVENTION

The disposable meat cooking tray is designed to virtually eliminate the clean-up of cooking meat, improve on the taste, and reduce the calories by reducing the residual grease that is produced during cooking and remains after cooking is complete. The meat-cooking tray is a double-layered foil tray with a perforated surface, under which lies an absorbent material, in one embodiment, or a chamber is formed beneath the top surface. When cooking meat under the broiler, the grease that is produced is drawn through the perforations by the absorbent material, or flows into the chamber in the other embodiment, and is trapped between the two layers of foil. When cooking is complete, one can simply remove the foil tray and throw it away. Grease will not run off the tray and there is no mess to clean up. An added benefit is the reduction in odor and smoke that is usually created by broiling meats, particularly bacon. As there is no grease left on the surface to burn, you are left with crisp, greaseless, tasty bacon strips.

Furthermore, the invention may be manufactured in a wide variety of shapes and sizes; square, oblong, elliptical, circular and other shapes are contemplated. Also, the invention may be marketed in roll or flat configurations, with suitable perforated tear lines so that one or more individual trays can be separated from a larger whole.

Accordingly, it is a principal object, advantage and feature of the invention to provide for a tray to cook meats with a minimum amount of residual grease.

It is another object, advantage and feature of the invention to provide for a tray for cooking meats that improves the taste of the meats cooked thereon.

A further object, advantage and feature of the invention is to provide for a tray for cooking meats which generates less odor and smoke during the cooking process.

A further object, advantage and feature of the invention is to provide for a tray for cooking bacon that is disposable, and when used, significantly reduces the amount of clean up that is usually required.

A further object, advantage and feature of the invention is to provide for a tray which absorbs grease as it is generated during cooking of meats.

Still a further object, advantage and feature of the invention is to provide for a cooking surface which is perforated, allowing the grease generated from meat during cooking to pass through these perforations.

Still a further object, advantage and feature of the invention is to provide for an absorbent layer to be sandwiched between the top perforated layer and a bottom layer which retains the absorbent material and grease therein.

Yet a further object of the invention is to provide a meat cooking tray including a perforated top layer and a solid bottom layer, so as to form a grease collection chamber or void between the layers.

Still a further object, advantage and feature of the invention is to provide for a meat cooking tray to be constructed so that it can be used as a package with meats such as bacon, and, once purchased, used as a tray for cooking the meat under a broiler.

Still a further object of the invention is to provide an improved meat cooking tray which may be manufactured in a wide variety of shapes and sizes,

It is an object of the invention to provide improved elements and arrangements thereof in an apparatus for the purposes described which is inexpensive, dependable and fully effective in accomplishing its intended purposes.

These and other objects, advantages and features of the present invention and its method of use will become readily apparent upon further review of the following specification and drawings.

### BRIEF DESCRIPTION OF THE DRAWINGS

FIG. 1 is an environmental, perspective view of a cooking tray for fatty meats according to the present invention.

FIG. 2 is a top view of the preferred embodiment of the invention showing the perforated top surface.

FIG. 3A is a sectional view through line 3A,B-3A,B shown in FIG. 2, and showing a first embodiment of the tray.

FIG. 3B is a sectional view through line 3A,B-3A,B shown in FIG. 2, and showing a second embodiment of the tray.

FIG. 4 is a bottom view of the invention.

FIG. 5 is an environmental, perspective view showing the cooking tray used as the package to display and sell the meat products.

Similar reference characters denote corresponding features consistently throughout the attached drawings.

### DETAILED DESCRIPTION OF THE PREFERRED EMBODIMENTS

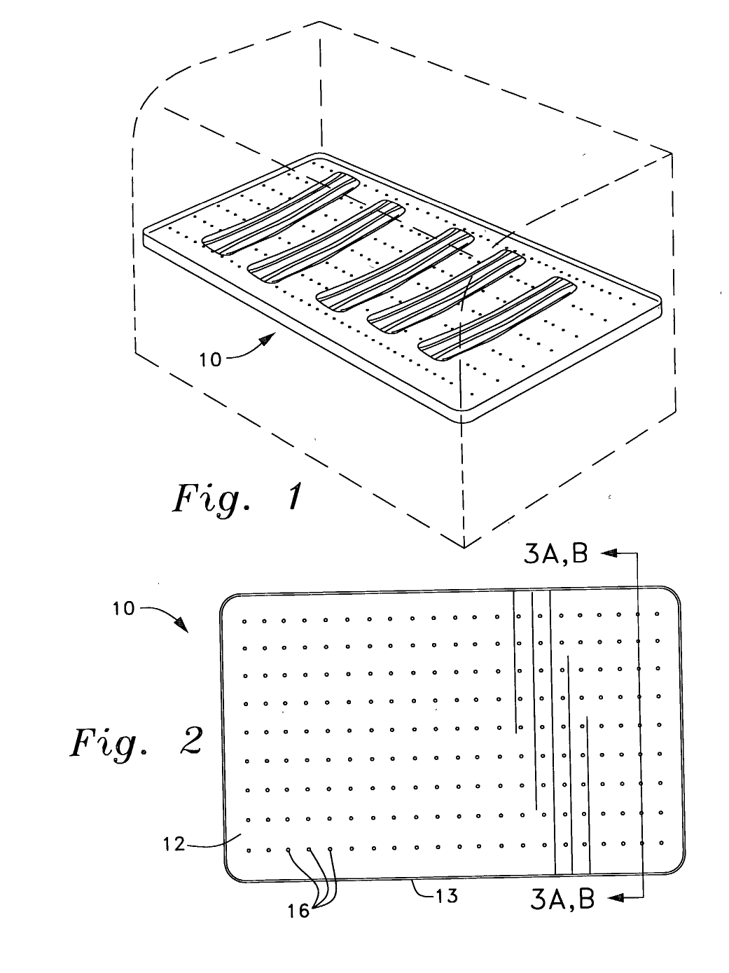

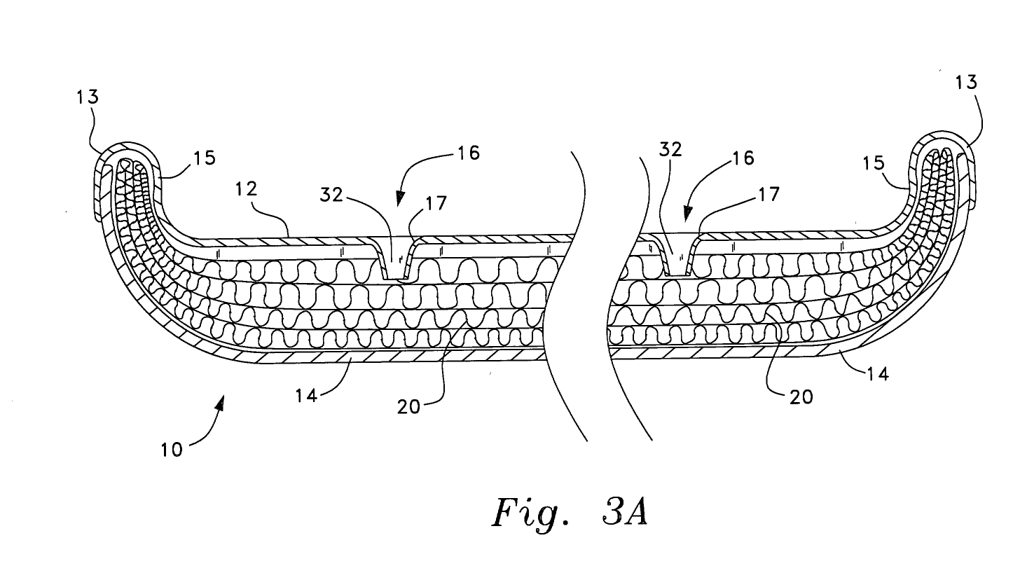

The present invention, as shown in FIG. 1, is a disposable cooking tray 10 for meats, particularly fatty meats, which is especially useful for cooking bacon under a broiler in a conventional oven. As shown in FIGS. 2, 3A, 3B and 4, tray 10 is constructed of two layers of aluminum foil 12 and 14, with layer 12 having a surface which has perforations 16 therethrough.

Perforations 16 can be made equidistant from each other across the entire surface of top layer 12. The distance between the perforations 16 can be varied with the fat content of the meat to be cooked on tray 10. The surface of layer 12 near its perimeter 13 can have fewer, greater or no perforations, and can have an elevated slope or a crimped edge 15 to retain grease on the layer 12 during cooking. Similarly, the diameter of the perforations 16 can be varied as desired.

In a preferred embodiment of the invention, under top perforated layer 12 lies an absorbent material 20 which is sandwiched between the top perforated layer 12 and the bottom layer 14, which may be thicker and/or more rigid than the top layer. The absorbent material 20 will absorb and retain an amount of grease at least equal to that generated by the cooking of the fatty meats placed on top layer 12. The absorbent material 20 can be one or more sheets of paper towels or constructed of absorbent paper material configured of a size and thickness optimal for this purpose. It also could be constructed of corrugated cardboard having grooves or channels thereon (not shown) for the grease to be carried. Or, absorbent material 20 can be an absorbent chemical composition such as Calcium Carbonate. The absorbent material 20 can have a fibrous construction with perforations therein to absorb the grease passing through the perforation 16 from top layer 12.

The absorbent material 20 will be configured in the preferred embodiment to fill the entire void between top layer 12 and bottom layer 14 and even if the composition of absorbent material 20 is flammable, it will not provide an environment to be combusted while meat is cooking on top layer 12. An adhesive substance between top layer 12 and absorbent material 20, and/or between bottom layer 14 and absorbent material 20, may be employed to retain absorbent material 20 in a fixed position between layers 12 and 14.

When cooking meat, particularly bacon, under the broiler, the grease that is produced is drawn through the perforations 16 into the absorbent material 20. The absorbent material 20 will be generally planar in its construction, but can be made to have a downward slope (not shown) toward the center of tray 10 or a downward slope 17 beneath some or all of the perforations 16.

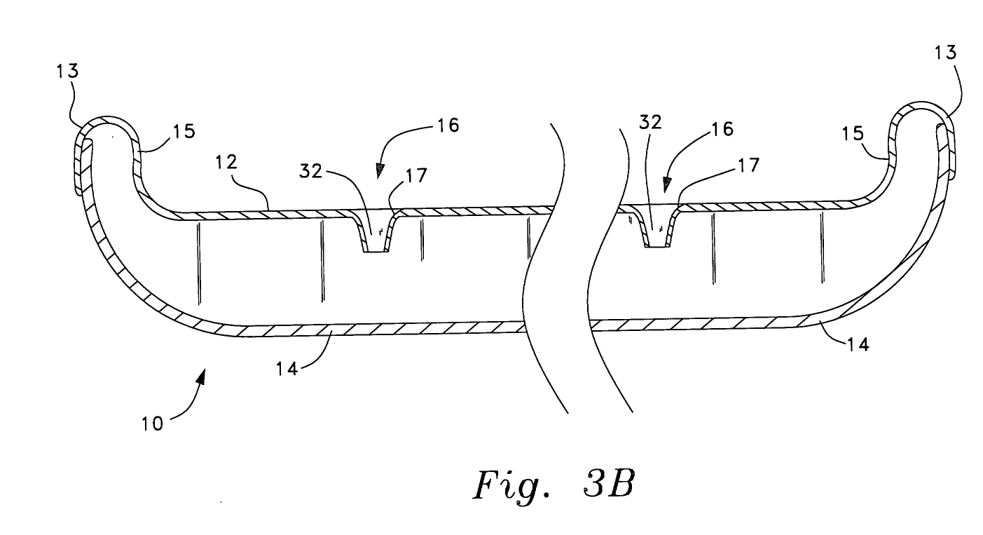

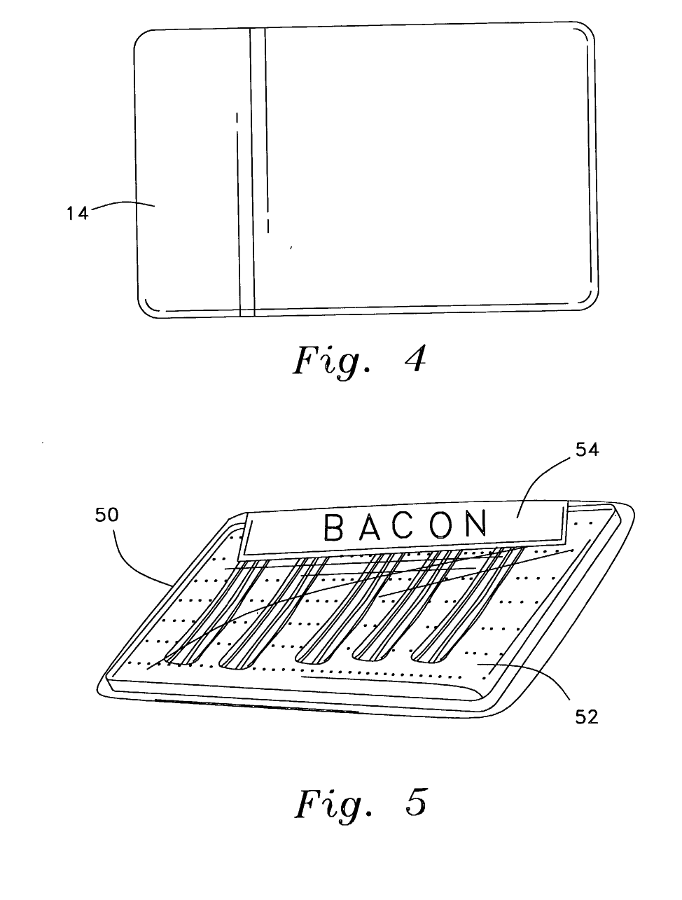

As shown in FIGS. 3A and 3B, the perforations 16 can be made so that a downward funnel 32 of the aluminum material of layer 12 is formed which helps channel grease from top layer 12 into absorbent material 20. The grease is then absorbed into material 20 (FIG. 3A) and is trapped between the top layer of foil 12 and, as shown in FIG. 4, the non-perforated impervious bottom layer 14. The bottom layer 14 can be made of foil, or a heat-resistant plastic material, if desired. When cooking is complete, one can simply remove the foil tray 10 and throw it away.

With reference to FIG. 3B, it is seen that the interior absorbent pad is eliminated, and the invention is constructed so as to form an interior, hollow void or chamber between the two layers 12 and 14. In this instance, the layers 12, 14 are made of material sufficiently strong so as to be shape retaining before and during use. This embodiment is less expensive to manufacture, since no interior pad is present, and works satisfactorily, especially with those meats (e.g., canadian bacon) that do not generate as much fat as conventional bacon. This embodiment would also be useful for broiling vegetables, hors d'oeuvres, and other food products. After use, the padless tray may be folded up and discarded.

FIG. 5 shows cooking tray 10 constructed so that it can be used as a point of purchase package 50 with bacon or other meats (particularly fatty meats), and once purchased, used as tray 10 for cooking the contents under the broiler. Point of purchase package 50 can be made in any desired size, for single servings, family size packages serving two to four people, or in half pound or full pound sizes. Package 50 can be constructed in a square shape to fit conveniently within a conventional oven and be placed on an oven rack below the broiler flame or heat element. Package 50 can be constructed with plastic or other suitable packaging 52 and product information, cooking instructions or disposal methods, on paper or cardboard 54 associated therewith, or other suitable material for storing and displaying the contents for sale, cooking and disposal.

It is to be understood that the present invention is not limited to the embodiments described above, but encompasses any and all embodiments within the scope of the following claims.

I claim:

1. A cooking tray which has a top layer with perforations therethrough, a bottom impervious layer, and absorbent material between said top and bottom layer.

2. The tray according to claim 1, further comprising point-of-purchase packaging and food products to be cooked on said tray when the point-of-purchase packaging is removed.

3. The tray according to claim 2, wherein the point-of-purchase packaging is a transparent plastic wrap sealing the food products on the tray, thus allowing for storage without spoilage, and visibility of the food products by prospective purchasers.

4. The tray according to claim 1, wherein the perforations in the top layer are constructed equidistant from each other.

5. The tray according to claim 1, wherein the perforations in the top layer are constructed with a diameter having a predetermined size which is optimal for the absorbent material to fully absorb grease generated from the cooking of food products on the tray.

6. The tray according to claim 1 wherein the top layer is constructed to channel the grease generated by cooking to flow toward the area of the center point of the top layer, and then channel through perforations into the absorbent material.

7. The tray according to claim 1, wherein the perforations in the top layer are constructed to extend downward into the absorbent material.

8. The tray according to claim 1, wherein there is a tray perimeter having an edge which serves to retain grease on the top layer of the tray.

9. The tray according to claim 1 wherein the absorbent material is constructed from paper towel type material, in layers of sufficient quantity to absorb grease.

10. The tray according to claim 1, wherein the absorbent material is a corrugated cardboard materials wherein the corrugated grooves facilitate the channeling of the grease away from the top layer.

11. The tray according to claim 1, wherein the absorbent material is a chemical composition having absorbent properties.

12. The tray according to claim 1, wherein the bottom tray is constructed of material having greater rigidity that the material of the top layer and is impervious to the passage of grease.

13. A cooking tray which has a top layer with perforations therethrough, a bottom impervious layer, and a peripheral rim formed by said layers, thereby defining a chamber for grease within said tray.

14. The tray according to claim 13, further comprising point-of-purchase packaging and food products to be cooked on said tray when the point-of-purchase packaging is removed.

15. The tray according to claim 14, wherein the point-of-purchase packaging is a transparent plastic wrap sealing the food products on the tray, thus allowing for storage without spoilage, and visibility of the food products by prospective purchasers.

16. The tray according to claim 13, wherein the perforations in the top layer are constructed equidistant from each other.

17. The tray according to claim 13 wherein the top layer is constructed to channel the grease generated by cooking to flow toward the area of the center point of the top layer, and then channel through perforations into said chamber.

18. The tray according to claim 13, wherein there is a tray perimeter having an edge which serves to retain grease on the top layer of the tray.

19. The tray according to claim 13, wherein the bottom tray is constructed of material having greater rigidity that the material of the top layer and is impervious to the passage of grease.

20. The tray according to claim 19, wherein the bottom tray is made of a heat-resistant plastic material.
